(19) United States
(12) Patent Application Publication
(10) Pub. No.: US 2026/0286533 A1
(43) Pub. Date: Sep. 24, 2026

(54) MEMBRANE-LESS SYSTEM FOR CONTINUOUS GENERATION OF GASES

(71) Applicant: TECHNION RESEARCH AND DEVELOPMENT FOUNDATION LTD., Haifa (IL)

(72) Inventors: Avner ROTHSCHILD, Haifa (IL); Ilya SLOBODKIN, Haifa (IL); Elena DAVYDOVA, Haifa (IL); Anna BREYTUS, Haifa (IL)

(21) Appl. No.: 19/473,623

(22) PCT Filed: Apr. 10, 2024
(86) PCT No.: PCT/IL2024/050357

§ 371 Date: Oct. 8, 2025

Related U.S. Application Data
(60) Provisional application No. 63/495,167, filed on Apr. 10, 2023.

(51) Int. Cl. C25B 1/04; C25B 9/70; C25B 11/081; C25B 15/08

(52) U.S. Cl. CPC C25B 1/04; C25B 9/70; C25B 11/081; C25B 15/083; C25B 15/087

(57) ABSTRACT

The technology disclosed herein generally concerns a system and a process for continuous generation of hydrogen and oxygen gases.

### TECHNOLOGICAL FIELD

The invention generally contemplates a system for continuous generation of hydrogen and oxygen gases, as well as other gases.

### BACKGROUND OF THE INVENTION

Green hydrogen produced by water electrolysis using renewable energies such as solar and wind is essential for reducing greenhouse gas emissions, especially in hard-to-abate industrial sectors such as steel, cement and ammonia production. The technologies that are currently available for green hydrogen production, at scale, are alkaline and polymer electrolyte membrane water electrolysis. In addition, anion exchange membrane and high-temperature solid oxide water electrolysis are emerging technologies that present potential advantages but struggle to achieve durability, long-term stability and competitive cost. At present, all four technologies are unable to compete with the low cost of grey hydrogen production by steam methane reforming (SMR), an industrial process that provides most of the hydrogen used today and produces greenhouse gases (CO₂ and methane) about twenty times more than the amount of hydrogen produced.

Efforts to mitigate SMR greenhouse gas emissions by carbon capture and storage have been seriously questioned in recent lifecycle assessment studies. Therefore, there is a pressing need to improve water electrolysis to support low-cost production of green hydrogen at terawatt scale and provide a cost-competitive alternative to natural gas and other fossil fuels. In this regard, advanced materials, and novel cell designs for next generation water electrolysis, have been recognized as topmost research priorities by Hydrogen Europe and other organizations. Specifically, membrane-less cell architectures present a promising potential for cost reduction and compact systems, as well as operational advantages such as high-pressure hydrogen production and operation in low quality water. Decoupled water electrolysis (DWE), where the hydrogen and oxygen evolution reactions (HER and OER, respectively) are decoupled in time and/or place, presents a disruptive concept that has spurred innovative efforts to develop membrane-less water electrolysis over the past decade. DWE may lead the way to safe operation without membranes, providing new opportunities to reshape water electrolysis and potentially overcome the fundamental barriers of this century-old technology.

DWE was first reported in 2013, introducing phosphomolybdic acid as a soluble redox couple (SRC) that functions as an electron-coupled-proton buffer (ECPB) and mediates the electron-coupled-proton exchange between the anodic OER and cathodic HER. To function as an effective mediator, the SRC must have a redox potential between the HER and OER potentials. Despite generating oxygen and hydrogen at different times in stepwise stages, a membrane was used to prevent redox shuttling of the polyoxomolybdate anions between the electrodes, and the efficiency was lower than conventional water electrolysis. Low efficiency is an inherent disadvantage of this method since the oxidation and reduction overpotentials of the SRC add up to those of the OER and HER, thus necessitating a larger voltage than in conventional water electrolysis without redox mediators. Subsequent studies pursuing this approach introduced different ECPBs in acidic electrolytes, but the efficiency remained low and a membrane was still necessary. Another disadvantage common to the systems reported employing this approach is the use of platinum group metal (PGM) catalysts, which is necessary due to operation in acid electrolytes where non-noble metals and their oxides are unstable. To address this limitation, alternative SRCs were introduced that function as proton-independent electron reservoirs and demonstrated DWE in a wide pH range from neutral to alkaline electrolytes. Without a proton buffer, substantial changes in pH were observed during operation, swinging from pH 6.5 at the end of the oxygen evolution stage to pH 9 at the end of the hydrogen evolution stage. Such pH swings have an adverse effect on efficiency. Indeed, the electrolytic efficiency in this study was low, 61% HHV at a current density of 10 mA/cm².

Another DWE scheme replaces the SRC by solid redox electrodes (SRE) that mediate the hydroxide ion (OH⁻) exchange between the hydrogen and oxygen evolution reactions at the primary electrodes (cathode and anode, respectively) in alkaline electrolyte. To this end, nickel (oxy) hydroxide electrodes such as those commonly used in rechargeable alkaline batteries (e.g., NiMH and NiCd batteries) were employed as auxiliary electrodes that mediate the hydroxide ion exchange between the HER at the cathode of one cell and the OER at the anode of another cell. Thereby, the electrolytic cell was divided into two separate cells that generate hydrogen and oxygen remotely from each other. This enables operation without membranes, paving the way for membrane-less DWE. However, using stationary SRE requires batch operation to regenerate the auxiliary electrodes (e.g., by swapping them from one cell to another) when they are fully (dis) charged, whereas SRCs support continuous operation in a flow system much like conventional electrolyzers.

A different DWE approach introduced an electrochemical-chemical cycle (ECC) whereby silicotungstic acid was applied as an SRC that was reduced electrochemically at the cathode while oxygen evolved at the anode, and then transferred into another cell where it was oxidized chemically and released hydrogen upon contact with a platinum catalyst (without applying electricity). An electrolytic efficiency of 63% HHV was achieved, and a membrane was used in the electrolytic cell to prevent redox shuttling.

The next leap in the evolution of DWE was to introduce an electrochemical-thermally-activated chemical (E-TAC) cycle that divides the OER into two sub-reactions and enables operation in near thermoneutral conditions. In the first stage (E), a cobalt-doped nickel hydroxide anode was electrochemically charged to nickel oxyhydroxide while hydrogen evolved at the cathode. This stage was performed in a cold (~25° C.) alkaline electrolyte, and was stopped prior to the onset of oxygen evolution, assuring that hydrogen was the sole gaseous product in this stage. Then, in the second stage (TAC), the cold electrolyte was replaced by a hot one (95° C.) that induced fast spontaneous reaction between the charged anode and water, regenerating the anode back to its initial state while producing oxygen, thereby completing the water decomposition cycle. The E-TAC process presents important advantages: membrane-less operation with a remarkable electrolytic efficiency of 98.7% HHV (at the cell level) at a current density of 50 mA/cm², identifying it as a potential competitor to conventional water electrolysis. Its membrane-less architecture leads the way to simple cell design, employing rolled electrode assemblies that can be piled up to form compact stacks, and operation at high pressure. This presents a unique advantage over traditional electrolysis with a parallel plate architecture where membranes and compression sealing prevent H₂/O₂ mixing.

### SUMMARY OF THE INVENTION

Green hydrogen produced by water electrolysis using renewable electricity is essential to achieving net-zero carbon emissions. Present water electrolysis technologies are uncompetitive with low-cost grey hydrogen produced from fossil fuels, limiting their scale-up potential. Disruptive processes that decouple the hydrogen and oxygen evolution reactions and produce them in separate cells or in different stages emerge as a prospective route to reduce system cost by enabling operation without expensive membranes and sealing components. Some of them divide the hydrogen or oxygen evolution reactions into electrochemical and chemical sub-reactions, leading the way to high efficiency. However, high efficiency and high throughput may be more confidently obtained in batch processes.

To improve on technologies of the art and provide a remedy to many of the disadvantages associated with the production of hydrogen and oxygen gases, the inventors of the technology disclosed herein have developed a unique electrolyzer system and a breakthrough process that produces hydrogen and oxygen in separate cells, yet supports high-efficiency continuous operation in a membrane-less system.

The system of the invention allows for an electrochemical-chemical cycle (ECC) that divides the oxygen evolution reaction (OER) into two sub-reactions: an electrochemical reaction and a chemical reaction, whereby an electrolyte solution (a water solution) comprising a soluble redox couple (SRC) supports a continuous operation in an isothermal process with high efficiency and high rate. The process of the invention operates in mild aqueous electrolytes at near neutral pHs (pH 7-9), thus reducing safety hazards and enabling use of benign materials that cannot be used under strong acid or alkaline electrolyte conditions.

Apart from the demonstrated generation of hydrogen and oxygen gas, in principle, systems and processes of the invention are surprisingly unique also in their ability to further generate chlorine (Cl₂) gas (using NaCl electrolyte, brine or seawater), or an oxygen-chlorine mixture.

Without wishing to be bound by theory, it is believed that the key to achieving these merits is a soluble redox couple (SRC) that (a) its reduced state is oxidized in an electrochemical reaction (red→ox+ne⁻) that complements a hydrogen evolution reaction (HER) without evolving oxygen or other volatile side products, and (b) in the presence of a suitable catalyst, its oxidized state (ox) spontaneously evolves oxygen in a chemical reaction that reduces it back to the reduced state (ox→red+O₂). To provide a driving force for this chemical reaction, the SRC is selected to have a reversible redox potential (E⁰) above the thermodynamic OER potential (1.23 V_{RHE}, vs. the reversible hydrogen electrode), whereas for high efficiency it should be oxidized at a low overpotential, and ideally below the OER onset potential (~1.6 V_{RHE} for state-of-the-art OER catalysts). This delicate balance dictates an SRC with a reversible redox potential of ~1.4 V_{RHE}±0.1V.

Based on these criteria, a halide ion and a halide oxide pair, herein designated “soluble halide redox couple” or “halide SRC” such as the bromide (Br⁻) and bromate (BrO₃⁻) couple or the chloride (Cl⁻) and chlorate (ClO₃⁻) couple, was selected as the SRC for systems and processes of the invention. The salts of both the reduced and oxidized species, e.g., the bromide-bromate couple: NaBr and NaBrO₃, and the chloride-chlorate couple: NaCl and NaClO₃, have high solubility in water, 946 and 394 g/L, for NaBr and NaBrO₃, respectively (at 25° C.), thus affording stable and consistent conditions.

In its broadest aspect, the invention provides a reduction/oxidation (redox) system comprising a plurality of reactors (or cells) for cycling a redox active halide-based electrolyte (a halide SRC) between an oxidized state and a reduced state, to thereby generate hydrogen gas in one of said plurality of reactors and oxygen gas in another of said plurality of reactors.

The invention further provides a redox system for continuous generation of hydrogen and oxygen gases, the system comprising a plurality of reactors for cycling a soluble halide redox couple (halide SRC), such that the halide SRC in a reduced state is oxidized (to provide electrons and protons and) to generate hydrogen gas, and the oxidized halide SRC is reduced to spontaneously evolve oxygen gas in a chemical reaction catalyzed by a suitable catalyst.

In some embodiments, hydrogen gas generation occurs through a hydrogen evolution reaction (HER), without evolving oxygen gas or other volatile side products.

In some embodiments, the plurality of reactors comprises at least one electrolytic cell (or an electrochemical cell) and at least one catalytic cell. In some embodiments, halide SRC electro-oxidation occurs in the electrolytic cell and the chemical reduction of the oxidized halide SRC occurs in the catalytic cell in presence of a catalyst.

The invention further provided is a redox system for continuous generation of hydrogen and oxygen gases, the system comprising a plurality of reactors for cycling a soluble halide redox couple (halide SRC), such that the halide SRC in a reduced state is electro-oxidized in an electrochemical reaction (that provides electrons and protons) and complements a hydrogen evolution reaction (HER), without evolving oxygen gas, and the oxidized halide SRC, in presence of a catalyst, spontaneously evolves oxygen.

In some embodiments, the halide SRC is selected to have a reversible redox potential (E⁰) greater than a thermodynamic oxygen evolution reaction (OER) potential, e.g., a potential greater than 1.23 V_{RHE} (at 20° C.). In some embodiments, the halide SRC is oxidable at a low overpotential, e.g., below the OER onset potential, e.g., ~1.6 V_{RHE} (at 20° C.).

Each of the potential values provided herein are, in some embodiments, within a±0.1V range (namely 1.23 V_{RHE}+0.1V, or 1.6 V_{RHE}±0.1V, etc).

In some embodiments, the halide SRC is selected to have a reversible redox potential of ~1.4 V_{RHE}+0.1V (at 20° C.).

The system comprises a plurality of reactors which are connected through an electrolyte flow. At least one of the reactors is an electrolytic cell (or reactor) and another of said plurality of reactors is a catalytic cell (or reactor). In some embodiments, at least one of the electrolytic cells and at least one of the catalytic cells are connected through an electrolyte flow, such that the direction of flow may be predesigned, e.g., in a direction parallel to or perpendicular to the face of the electrodes, or at any orientation to the electrodes. In some embodiments, the system comprises means, e.g., tubing, pipes, flow-controllers, pumps, etc., to directionally cycle the redox active material between the plurality of reactors.

In some embodiments, the system comprises a plurality of reactors and means to directionally cycle a redox active halide-based electrolyte solution between said reactors, wherein the electrolyte solution comprises the halide SRC, namely a mixture of both the oxidized and reduced forms of the halide SRC. A first of said plurality of reactors is configured for generating an amount or a concentration of the oxidized form of said halide SRC in the electrolyte solution while evolving hydrogen gas. The hydrogen gas is removed from the solution (e.g., by gas separation) before the solution flows to a second of said plurality of reactors where the oxidized form is reduced while evolving oxygen gas. Following removal of the oxygen gas from the solution (e.g., by gas separation), the solution now comprising the reduced form of the halide SRC flows back to the first of said reactors for electro-oxidation; and the redox reaction is continuously repeated to generate the gases. In other words, the electrolyte solution comprises at all times a mixture of the oxidized and reduced forms of the halide SRC, wherein an enriched concentration of the oxidized form is present at the exit of the electrolytic cell, and conversely more of the reduced form is present at the exit of the catalytic cell.

As the flow is directional, namely in a single direction between the reactors, exchange of gases is substantially prevented by ensuring removal or separation of the generated gas (hydrogen or oxygen) from the solution after each redox reaction. The gases can be separated from the solution in the electrolytic and catalytic cells themselves, or in intermediate gas separation cells positioned between the electrolytic and catalytic cells. Once separated, the gases may be purified and collected. Such purification may include drying and deoxo treatments to remove water vapor and residual oxygen, respectively, from the hydrogen gas stream going out of the system, and/or similar processes to remove water vapor and residual hydrogen from the oxygen gas stream.

The removal, separation and purification of the gases may be achieved by any means known in the art. Typically, the system will comprise means for gas separation, drying, deoxo process and/or gas purification. In other cases, such treatments may be carried out separately, i.e., in a sperate purification or post treatment unit or at any time after the gases have been separated.

In some embodiments, the system may comprise a hydrogen gas separator, positioned in a flow path of the electrolyte solution exiting the electrolytic cell. Following separation of the hydrogen gas from the liquid electrolyte, the electrolyte solution flows into the catalytic cell.

In some embodiments, the system may comprise an oxygen gas separator, positioned in a flow path of the electrolyte solution exiting the catalytic cell. Following separation of the hydrogen gas from the liquid electrolyte, the electrolyte solution flows back into the electrolytic cell.

The system may further comprise an oxygen gas scrubber and/or a hydrogen gas scrubber, as known in the art.

The invention further provides a system for continuous generation of oxygen and hydrogen gases, the system comprising an electrolytic cell and a catalytic cell, each of the electrolytic and catalytic cells being configured to receive and hold a halide-based electrolyte solution comprising a halide SRC, wherein the electrolytic cell is adapted to oxidize said halide SRC to produce hydrogen gas; and wherein the catalytic cell comprises a catalyst (such as RuO₂ or other reducing catalysts, e.g., in nanoparticulate forms) and is adapted for reducing the oxidized halide SRC to generate oxygen gas, and wherein the system further comprises means to cause directional cycling of the solution comprising the oxidized halide SRC (being a bromate-rich or a chlorate-rich solution) from the electrolytic cell into the catalytic cell and a reduced halide SRC (being a bromide-rich or chloride-rich solution) from the catalytic cell to the electrolytic cell.

The system may further comprise means for separating the gases, as disclosed herein.

In some embodiments, systems of the invention are membrane-less electrolyzers. Despite the fact that systems of the invention are sufficiently effective for generating hydrogen and oxygen gases, and separating them, even in absence of a membrane, in some configurations a membrane may be desired and present.

The catalyst used for reduction of the oxidized form of the halide SRC may be any reductive catalyst known in the art. The catalysts may be of a metal M selected from Ru, Ni, Mo, Co, Mn, Fe, V, and Cr, as well as alloys thereof with other metals, oxides or hydroxides thereof and alloys of the oxides or hydroxide forms. Non-limiting examples of catalysts include RuO₂ (e.g., RuO₂ Adams or other RuO₂ nanoparticles), and Ru₁₋ₓMₓO₂, wherein M is a metal selected from Ni, Mo, Co, Mn, Fe, V, and Cr, and wherein 0.5<x<1.

The system may further comprise one or more intermediating cells positioned at a flow path of a halide RSC solution from the electrolytic cell to the catalytic cell and/or in a flow path from the catalytic cell to the electrolytic cell. These intermediating cells may be gas separation cells, as disclosed herein.

The invention further provides a system for continuous generation of oxygen and hydrogen gases, the system comprising an electrode assembly and two or more reactors, wherein
at least one of said reactors being an electrolytic cell comprising an electrode assembly (comprising an anode and a cathode) configured to evolve H₂ gas and oxidize halide electrolyte ions, e.g., bromide or chloride ions, into a corresponding oxidized halide form, e.g., bromate ions or chlorate ions, respectively; and
at least one another of said reactors being a catalytic cell comprising at least one catalyst capable of reverting the oxidized halide form of the electrolyte ions to a reduced form;
wherein the oxidized electrolyte is flown from the electrolytic cell to the catalytic cell and the reduced electrolyte is flown from the catalytic cell to the electrolytic cell.

The invention further provides a system for continuous generation of gases, the system comprising
an electrolytic cell comprising a halide-containing electrolyte solution and an electrode assembly configured to oxidize halide ions in the solution into halide oxide ions;
a catalytic cell comprising at least one catalyst capable of reducing the halide oxide ions to halide ions;
and means for causing directional flow of halide oxide ions rich electrolyte solution from the electrolytic cell to the catalytic cell and flow of halide ions rich electrolyte solution form the catalytic cell to the electrolytic cell.

The electrode assembly provided in the electrolytic cell includes an anode electrode and a cathode electrode. Both electrodes may be selected amongst known electrodes and electrode materials. In some embodiments, the cathode may be selected amongst Pt comprising or Pt electrodes; Ni comprising or Ni electrodes; N-doped or P-doped or S-doped Ni electrodes. In some embodiments, the anode may be selected from a material comprising RuO₂ or an electrode formed of RuO₂, such as a TiO₂/Ti supported RuO₂ dimensionally stable anode (RuO₂—TiO₂/Ti DSA); or other mixed metal oxide (MMO) or mixed metal hydroxide (MMH) electrodes.

In some embodiments, the cathode is a Pt electrode (or Pt coated electrode) and the anode is RuO₂—TiO₂/Ti DSA.

In some embodiments, the cathode is provided with a semipermeable chromium hydroxide coating. In other words, in some embodiments, the cathode is a Pt electrode coated with a semipermeable film of chromium hydroxide or other hydroxide layer. In some embodiments, the electrode (cathode) may be coated by a thin polymer layer.

As used herein, the system of the invention is “a continuous cyclic reduction/oxidation (redox) system” which permits “continuous generation of gases”. Both hydrogen and oxygen gases may be generated via a cyclic redox scheme, whereby a halide-based electrolyte solution comprising a halide SRC is continuously and sequentially reduced and oxidized to simultaneously (at the same time) and separately (in different cells or reactors) generate hydrogen and oxygen gases. Hydrogen gas is generated in the electrolytic cell on the cathode, and oxygen gas is generated in the catalytic cell, as further disclosed herein. The risk of generating both gases within a single cell is removed, despite absence of a membrane, and thus concomitant generation of gases is possible. Despite the fact that two cells are utilized to separate between the production of hydrogen gas and oxygen gas, the electrolytic cell comprises at all times an effective concentration of the electrolyte halide ions, e.g., bromide ions or chloride ions, that is sufficient to allow an effective, continuous proper generation of hydrogen gas. In a similar fashion, the catalytic cell comprises at all times an effective amount of the oxidized halide ions, e.g., bromate or chlorate ions, that has a sufficiently large residence time to allow for an effective, continuous and proper generation of oxygen.

The halide-based electrolyte solution is an aqueous solution comprising a bromide salt or a chloride salt capable of generating free bromide ions (Br⁻) or free chloride ions (Cl⁻) in solution. The ions may be provided in a form of metal salts of Br or Cr (or I), such as NaBr, KBr, NaCl, and others (e.g., NaI, KI). When oxidized in the electrolytic cell, the ions are converted into their corresponding oxide forms, i.e., bromate (BrO₃⁻) or chlorate (ClO₃⁻), respectively. In the reverse reaction, the oxide forms are reduced in the catalytic cell to generate the free halide ions, which again electro-oxidize in the electrolytic cell.

The catalytic cell is associated to the electrolytic cell through means that are configured to cause directional flow or cycling of the electrolyte solution. The means are or comprise at least one valve or pump or any mechanical structure that is structured and operable to permit flow of the oxidized electrolyte solution from the electrolytic cell and prevent flow of oxygen-containing solution from the catalytic cell to the electrolytic cell. The inlet valve directing flow from the electrolytic cell may be positioned at a lower end of the catalytic cell to allow flow of the solution from a bottom region of the electrolytic cell to a bottom region of the catalytic cell, and an outlet valve at the top region of the catalytic cell, thereby maximizing exposure of the catalytic material to the halide oxide rich electrolyte and avoiding spillover of oxidized electrolyte solution back into the electrolytic cell. Thus, in some embodiments, the electrolytic cell and the catalytic cell are associated via means including a valve unit or a pump positioned at a lower region of both cells and allowing flow of the electrolyte from a bottom region of the electrolytic cell to a bottom region of the catalytic cell.

Following gas separation, as disclosed herein, flow of reduced electrolyte from the catalytic cell to the electrolytic cell may be through a communication channel or tube or pipe or an opening associating the two cells and provided at a higher portion of the cells, as depicted in FIG. 1.

As the electrolyte flow is directional, as explained herein, and as the electrolyte is substantially free of gases that have been removed and separated from the electrolyte before it flows from one cell to another, the exchange of gases between the cells is substantially prevented, limiting presence of hydrogen gas to the electrolytic cell and oxygen gas to the catalytic cell. The electrode active material being formed as part of the electrode assembly does not change position or does not flow between the cells. Also, the catalyst used in the catalytic cell is provided embedded in a support within the catalytic cell or is suspended or made to float (free or loaded on a porous support) within the catalytic cell. Where the catalyst is loaded or provided on a support, the support may be a porous support that may be microscopic, or meso/nanoscopic, thereby allowing liquid electrolyte to flow through the catalytic cell while providing high surface area for the catalytic interaction between the catalyst and the electrolyte. Where the catalyst is suspended or made to float in the electrolyte within the catalytic cell, it is separated from the electrolyte flowing out of the catalytic cell and re-injected back to electrolyte flowing into the catalytic cell using an ultrafiltration system.

FIG. 1 illustrates a system of the invention for the decoupled production of hydrogen and oxygen gases, in separate cells or reactors, using a bromide-based or bromide-rich electrolyte solution comprising the halide SRC Br⁻/BrO₃⁻ that stores and releases oxygen by turns.

Without wishing to be bound by theory, the following discussion provides some insight as to the reactions leading to the generation of oxygen and hydrogen gases.

The electrolytic cell comprises two electrodes, a cathode that generates hydrogen gas by the HER (Rxn 1), and an anode where the bromide electrooxidation reaction (BER, Rxn 2) takes place:

$$2 {H}^{+} + 2 {e}^{-} \to {H}_{2} \qquad ( 1 )$$

$$2 {Br}^{-} \to {Br}_{2} + 2 {e}^{-} \qquad ( 2 )$$

The bromine molecules (Br₂) produced at the anode react with water in the bulk of the aqueous electrolyte to form hypobromous acid (HBrO, Rxn 3) that forms hypobromite anions (BrO⁻) and protons by dissociation (Rxn 4). The hypobromite anions react with hypobromous acid to form bromate anions (BrO₃⁻, Rxn 5), the main reaction product:

$${Br}_{2} + {H}_{2} O ⇌ HBrO + {H}^{+} + {Br}^{-} \qquad ( 3 )$$

$$HBrO ⇌ {H}^{+} + {BrO}^{-} \qquad ( 4 )$$

$$2 HBrO + {BrO}^{-} \to {BrO}_{3}^{-} + 2 {Br}^{-} + 2 {H}^{+} \qquad ( 5 )$$

The overall anode-related process, Rxns 2-5, can be summarized by Rxn 6:

$${Br}^{-} + 3 {H}_{2} O \to {BrO}_{3}^{-} + 6 {H}^{+} + 6 {e}^{-} \qquad ( 6 )$$

While the HBrO and BrO⁻ intermediate products give rise to the desired bromate product (Rxn 5), they can also lead to undesired side reactions as depicted in Rxns 7-11:

$$6 {BrO}^{-} + 3 {H}_{2} O \to 2 {BrO}_{3}^{-} + 6 {H}^{+} + 4 {Br}^{-} + 1.5 {O}_{2} + 6 {e}^{-} \qquad ( 7 )$$

$$HBrO + 2 {e}^{-} \to {Br}^{-} + {OH}^{-} \qquad ( 8 )$$

$${BrO}^{-} + {H}_{2} O + 2 {e}^{-} \to {Br}^{-} + 2 {OH}^{-} \qquad ( 9 )$$

$${BrO}_{3}^{-} + 3 {H}_{2} O + 6 {e}^{-} \to {Br}^{-} + 6 {OH}^{-} \qquad ( 10 )$$

$${BrO}_{3}^{-} + 2 {H}_{2} O + 4 {e}^{-} \to {BrO}^{-} + 4 {OH}^{-} \qquad ( 11 )$$

To suppress the anodic side-reaction that produces oxygen (Rxn 7), the electrolyte temperature and pH may be tuned to reach an optimal degree of HBrO dissociation (Rxn 4) that gives rise to an optimal ratio between the intermediate products that support high selectivity for the desired product, i.e., bromate (BrO₃⁻). Thus, operation at a temperature between 15 and 95° C. and a pH between 4 and 10 may provide optimal conditions to suppress oxygen evolution (Rxn 7) and achieve close to 100% Faradic efficiency for bromate production (Rxn 6).

To suppress the cathodic backward reactions that reduce the oxidized brome species back to bromide (Rxns 8-11), a small amount (as small as 0.1 g/L or an amount between 0.1 and 3 g/L or between 1 and 3 g/L) of sodium dichromate (Na₂Cr₂O₇) may be added to the sodium bromide (NaBr) aqueous electrolyte. The dichromate anions (Cr₂O₇²⁻) are reduced and deposited on the cathode, coating it with a semipermeable chromium hydroxide layer that suppresses the cathodic loss reactions (Rxns 8-11), while allowing the HER to occur without hindrance. Thus, adding Na₂Cr₂O₇ enables to achieve high Faradaic efficiency without needing a membrane to divide the cell into anodic and cathodic compartments, enabling a membrane-less process.

Thus, a process of the invention may comprise a step of generating hydrogen gas in an electrolytic cell of a system of the invention, wherein the electrolyte solution comprises Br⁻/BrO₃⁻ ions as the soluble redox couple (SRC), an amount of sodium dichromate (Na₂Cr₂O₇) as a source of dichromate anions (Cr₂O₇²⁻), and wherein the electrolyte is maintained under conditions suitable for generating hydrogen gas.

The catalytic cell comprises a catalyst which may be provided in any form, e.g., immobilized form, which maintains the catalyst within the boundaries of the catalytic cell. In some cases, the catalyst may be provided in a form of a column embedded with a catalyst, or within catalyst cages or polymeric materials or ceramic honeycombs. The catalyst may be selected to facilitate the catalytic decomposition of bromate ions (BrO₃⁻ anions) formed in the electrolytic cell into bromide (Br⁻) and generate oxygen (O₂), thereby regenerating the electrolyte and evolving oxygen:

$$2 {BrO}_{3}^{-} \to 2 {Br}^{-} + 3 {O}_{2} \qquad ( 12 )$$

Putting it differently, the bromate or chlorate ions are produced in series of homogenous chemical reactions in the bulk solution. The first step occurs at the anode, where bromide/chloride ions are electro-oxidized to bromine/chlorine (Rxn 2). From here on, a sequence of homogeneous chemical reactions in the bulk solution (Rxns 3-5) leads, eventually, to the formation of bromate or chlorate. These reactions could occur anywhere downstream from the anode (in the electrolytic cell) to the catalyst (in the catalytic cell). In other words, the conversion from bromide/chloride to bromate/chlorate does not necessarily have to take place within the electrolytic cell, except for the first step (Rxn 2). The subsequent steps (Rxns 3-5) could also occur in any intermediate cell that is positioned downstream to the electrolytic cell, such as the (bottom of the) catalytic cell, or in an intermediate “mixing” cell provided between the electrolytic and catalytic cells.

Without wishing to be bound by theory, an intermediate cell positioned between the cells has a potential in “delaying” the conversion of bromine/chlorine to bromate/chlorate in order to prevent backward reactions by utilizing the natural phase separation in the system and to remove the oxidized products away from the cathode that could reduce them (which would degrade the Faradaic efficiency as some electrons will not lead to H₂ production).

The intermediate cell, if present, would be free of electrodes. The intermediate cell is configured to permit mixing of the oxidized electrolyte to complete the conversion from bromine/chlorine and other oxidized intermediates to bromate/chlorate ions. In principle, this may be assisted by some catalyst. Eventually, the bromate/chlorate must be reduced back to bromide/chloride (and evolve oxygen).

In some cases, the intermediate cells may be gas separation cells.

The bromine/chlorine produced at the anode (of the electrolytic cell) is denser (heavier) than water and therefore sinks down to the bottom of the electrolytic cell as soon as it is produced. Stirring mixes the solution and wipes out this phase separation. Without stirring or mixing, phase separation may be advantageous as it removes the oxidized electrolyte (formed at the anode) away from the cathode-thereby reducing the risk of reducing the oxidized products at the cathode which degrades the Faradaic efficiency for hydrogen production (because some of the electrons reduce bromo or chloro-species rather than water/protons).

The invention further provides a provision of a process for simultaneously generating hydrogen and oxygen gases, the process comprising oxidizing a reduced form of a halide SRC in an electrochemical reaction under conditions complementing a hydrogen evolution reaction (HER), without evolving oxygen gas, and reducing the oxidized form of the halide SRC to spontaneously generate oxygen gas.

In some embodiments, the halide SRC is as defined herein.

In some embodiments, the halide SRC is selected to have a reversible redox potential (E⁰) above a thermodynamic OER potential, e.g., of 1.23 V_{RHE}. In some embodiments, the halide SRC is oxidized at a potential below an OER onset potential, e.g., of ~1.6 V_{RHE}. In some embodiments, the halide SRC has a reversible redox potential of ~1.4 V_{RHE}±0.1 V (at 20° C.).

In some embodiments, the halide SRC is provided in an electrolyte aqueous solution. In some embodiments, the electrolyte solution is maintained at a temperature and/or pH selected to reach maximum HBrO dissociation. In some embodiments, the process is carried out at an electrolyte solution temperature between 15 and 95° C. In some embodiments, the process is carried out a solution pH between 4 and 10.

In some embodiments, the process is carried out at an electrolyte solution temperature between 15 and 95° and a pH between 4 and 10.

The electrolyte solution is typically an aqueous solution comprising the halide SRC and one or more additive such as oxidizing agents, e.g., such as KOH or NaOH. In some embodiments, the electrolyte solution may comprise an oxidizing material in a form of a chromium salt. In some embodiments, the chromium salt is a dichromate salt, e.g., sodium dichromate. In some embodiments, the sodium dichromate is provided at a concentration in the range of 0.1-3 g/L.

In some embodiments, the process comprises collecting the generated hydrogen and oxygen gases. In some embodiments, the process comprises separating a volume of bromine/chlorine formed during the electrocatalytic reaction.

The invention further provides a process for simultaneously generating hydrogen and oxygen gases, the process comprising oxidizing a reduced form of a halide SRC being a bromide SRC or a chloride SRC in an electrolytic cell, under conditions complementing hydrogen evolution, without generating oxygen gas, and reducing the oxidized form of the halide SRC to spontaneously generate oxygen gas, wherein the halide SRC is provided in an electrolyte solution maintained at a pH between 4 and 10 and at a temperature between 15 and 95°.

The invention further provides a halide-based electrolyte solution (aqueous solution) comprising a redox active halide SRC, as defined herein, wherein the solution is for use in a system or a process for generating hydrogen and oxygen gases in a continuous membrane-less system or process; the halide SRC comprising a reduced form and an oxidized form of the halide, such that a concentration of the reduced form or the oxidized form in the electrolyte solution is electrochemically or catalytically adjusted to generate hydrogen and oxygen gases.

In some embodiments, the halide is Br or Cl and the SRC is a bromide (Br) and bromate (BrO₃⁻) couple or a chloride (Cl⁻) and chlorate (ClO₃⁻) couple.

In some embodiments, the solution is maintained at a pH between 4 and 10 and at a temperature between 15 and 95°.

In some embodiments, the electrolyte solution is an aqueous solution comprising the halide SRC and one or more additives such as oxidizing agents, e.g., such as KOH or NaOH. In some embodiments, the electrolyte solution may comprise an oxidizing material in a form of a chromium salt. In some embodiments, the chromium salt is a dichromate salt, e.g., sodium dichromate. In some embodiments, the sodium dichromate is provided at a concentration in the range of 0.1-3 g/L.

The invention further provides:

A reduction/oxidation (redox) system comprising a plurality of reactors for cycling a redox active halide-based electrolyte solution between an oxidized state and a reduced state, to thereby simultaneously generate hydrogen gas in one of said plurality of reactors and oxygen gas in another of said plurality of reactors.

In any configuration of a system of the invention, the system may comprise a hydrogen gas separator and an oxygen gas separator.

In any configuration of a system of the invention, the system may be for continuous generation of the hydrogen and the oxygen gases, wherein the halide-based electrolyte solution comprises a soluble halide redox couple (halide SRC).

In any configuration of a system of the invention, the halide SRC in a reduced state may be oxidized to generate the hydrogen gas, and the oxidized halide SRC may be catalytically reduced to spontaneously evolve the oxygen gas.

In any configuration of a system of the invention, oxidation of the halide SRC proceeds electrochemically.

A redox system for continuous generation of hydrogen gas and oxygen gases, the system comprising a plurality of reactors for cycling a halide-based electrolyte solution comprising a soluble halide redox couple (halide SRC), such that the halide SRC in a reduced state is oxidized in an electrochemical reaction complementing hydrogen gas evolution, without evolution of oxygen gas, and the oxidized halide SRC, in presence of a catalyst, spontaneously evolves oxygen.

In any configuration of a system of the invention, the system may comprise a hydrogen gas separator for removing the hydrogen gas and an oxygen gas separator for removing the oxygen gas.

In any configuration of a system of the invention, the plurality of reactors may be connected through an electrolyte flow of said halide-based electrolyte solution.

In any configuration of a system of the invention, at least one reactor may be an electrolytic cell (or reactor) and another of said plurality of reactors is a catalytic cell (or reactor).

In any configuration of a system of the invention, the at least one electrolytic cell and the at least one catalytic cell are connected through an electrolyte flow, such that the direction of flow is predesigned.

In any configuration of a system of the invention, the system may comprise an electrode assembly, wherein optionally the electrolyte flow is parallel to or perpendicular to a face of the electrodes.

In any configuration of a system of the invention, the system may comprise means to directionally cycle the redox active halide-based electrolyte solution between the plurality of reactors.

In any configuration of a system of the invention, the system may comprise the plurality of reactors and means to directionally cycle the redox active halide-based electrolyte solution between said reactors, wherein the electrolyte solution comprises a halide mixture of oxidized and reduced forms of the halide SRC.

In any configuration of a system of the invention, the electrolyte solution may comprise a mixture of oxidized and reduced forms of the halide SRC, wherein an enriched concentration of the oxidized form is present at an exit of the electrolytic cell, and more of the reduced form is present at an exit of the catalytic cell.

In any configuration of a system of the invention, the system may be for continuous generation of oxygen and hydrogen gases, the system comprising an electrolytic cell and a catalytic cell, each of the electrolytic and catalytic cells being configured to receive and hold a halide-based electrolyte solution comprising the halide SRC, wherein the electrolytic cell is configured to oxidize said halide SRC to produce hydrogen gas; the catalytic cell comprises a catalyst and is configured for reducing the oxidized halide SRC to generate oxygen gas, the system further comprises means to cause directional cycling of the solution comprising the oxidized halide SRC from the electrolytic cell into the catalytic cell and a reduced halide SRC from the catalytic cell to the electrolytic cell; and wherein the system further comprising a hydrogen gas separator and an oxygen gas separator.

In any configuration of a system of the invention, the system may further comprise one or more intermediating cells positioned at a flow path of a halide RSC solution from the electrolytic cell to the catalytic cell and/or in a flow path from the catalytic cell to the electrolytic cell.

A system for continuous generation of oxygen and hydrogen gases, the system comprising an electrode assembly and two or more reactors, wherein
at least one of said reactors being an electrolytic cell comprising an electrode assembly and configured to oxidize halide electrolyte ions into a corresponding oxidized halide form and to evolve hydrogen gas; and
at least one another of said reactors being a catalytic cell comprising at least one catalyst capable of reverting the oxidized halide form of the electrolytic cell to a reduced form;
wherein the oxidized halide electrolyte is flown from the electrolytic cell to the catalytic cell and the reduced halide electrolyte is flown from the catalytic cell to the electrolytic cell.

In any configuration of a system of the invention, the system may comprise a hydrogen gas separator and an oxygen gas separator.

In any configuration of a system of the invention, the system may comprise an electrode assembly in the electrolytic cell, wherein said assembly comprises a cathode selected from Pt comprising electrodes or Pt electrodes; Ni comprising electrodes or Ni electrodes; N-doped or P-doped or S-doped Ni electrodes.

In any configuration of a system of the invention, the system may comprise an electrode assembly in the electrolytic cell, wherein said assembly comprises an anode selected from RuO₂ comprising electrode or RuO₂ electrodes.

In any configuration of a system of the invention, the anode may be a TiO₂/Ti supported RuO₂ dimensionally stable anode (RuO₂—TiO₂/Ti DSA).

In any configuration of a system of the invention, the system may comprise a Pt electrode or a Pt coated cathode and a RuO₂—TiO₂/Ti DSA anode.

In any configuration of a system of the invention, the cathode may be provided with a semipermeable chromium hydroxide film.

In any configuration of a system of the invention, the cathode may be a Pt electrode coated with a semipermeable film of chromium hydroxide.

In any configuration of a system of the invention, the system may be membrane-less.

In any configuration of a system of the invention, the halide-based electrolyte solution comprises a halide SRC selected to have a reversible redox potential (E₀) greater than a thermodynamic oxygen evolution reaction (OER) potential.

In any configuration of a system of the invention, the reversible redox potential is greater than 1.23 V_{RHE} (at 20° C.).

In any configuration of a system of the invention, the halide SRC may be oxidable at an overpotential below the oxygen evolution reaction (OER) onset potential.

In any configuration of a system of the invention, the potential may be ~1.6 V_{RHE} (at 20° C.).

In any configuration of a system of the invention, the halide SRC may be selected to have a reversible redox potential of ~1.4 V_{RHE}±0.1 V (at 20° C.).

In any configuration of a system of the invention, the catalytic cell may comprise a catalyst material immobilized within the boundaries of the catalytic cell.

In any configuration of a system of the invention, the system may comprise a catalyst for causing reduction of the oxidized form of the halide SRC.

In any configuration of a system of the invention, the catalyst may be selected from Ru, Ni, Mo, Co, Mn, Fe, V, and Cr-based catalysts, alloys thereof with other metals, oxides or hydroxides thereof, and alloys of the oxides or hydroxide forms.

In any configuration of a system of the invention, catalyst may be or may comprise RuO₂ or is or comprises Ru₁₋ₓMₓO₂, wherein M is a metal selected from Ni, Mo, Co, Mn, Fe, V, and Cr, and wherein 0.5<x<1.

In any configuration of a system of the invention, the halide SRC may be a bromide SRC or a chloride SRC.

In any configuration of a system of the invention, the catalytic cell may be associated to the electrolytic cell through at least one valve or pump or a mechanical structure configured and operable to permit flow of the oxidized electrolyte solution from the electrolytic cell and prevent flow of oxygen-containing solution from the catalytic cell to the electrolytic cell.

In any configuration of a system of the invention, the system may comprise an inlet valve directing flow from the electrolytic cell, wherein the inlet valve is positioned at a lower end of the catalytic cell to allow flow of the solution from a bottom region of the electrolytic cell to a bottom region of the catalytic cell, and an outlet valve at the top region of the catalytic cell.

A system for continuous generation of gases, the system comprising an electrolytic cell and a catalytic cell, each of the electrolytic cell and catalytic cell being configured to receive and hold a bromide-based electrolyte solution, the electrolytic cell comprising an electrode assembly adapted to oxidize bromide ions and produce bromate ions and hydrogen gas, and the catalytic cell comprising a catalyst capable of reducing the bromate ions to bromide ions and produce oxygen gas, and wherein
the system comprises means to cause directional cycling of the bromate ions solution from the electrolytic cell into the catalytic cell and a bromide ions solution from the catalytic cell to the electrolytic cell.

In any configuration of a system of the invention, the system may comprise an oxygen gas separator and a hydrogen gas separator.

A process for simultaneously generating hydrogen and oxygen gases, the process comprising oxidizing a reduced form of a halide SRC in an electrochemical reaction under conditions complementing a hydrogen evolution reaction (HER), without evolving oxygen gas, and reducing the oxidized form of the halide SRC to spontaneously generate oxygen gas.

In any configuration of a process of the invention, the process may comprise separating the hydrogen gas following the HER reaction and separating the oxygen gas spontaneously generated following reduction of the oxidized form of the SRC.

In any configuration of a process of the invention, the halide SRC may be a bromide SRC or a chloride SRC.

In any configuration of a process of the invention, the halide SRC may be a bromide SRC.

In any configuration of a process of the invention, the halide SRC may be selected to have a reversible redox potential (E₀) greater than a thermodynamic oxygen evolution reaction (OER) potential.

In any configuration of a process of the invention, the reversible redox potential may be greater than 1.23 V_{RHE} (at 20° C.).

In any configuration of a process of the invention, the halide SRC may be oxidable at an overpotential below the oxygen evolution reaction (OER) onset potential.

In any configuration of a process of the invention, the potential may be ~1.6 V_{RHE} (at 20° C.).

In any configuration of a process of the invention, the halide SRC may be selected to have a reversible redox potential of ~1.4 V_{RHE}±0.1 V (at 20° C.).

In any configuration of a process of the invention, the electrolyte solution may be maintained at a temperature and/or pH selected to reach a maximum HBrO dissociation.

In any configuration of a process of the invention, the process may be carried out at an electrolyte solution temperature between 15 and 95° C.

In any configuration of a process of the invention, the process may be carried out a solution pH between 4 and 10.

In any configuration of a process of the invention, the process may be carried out at an electrolyte solution temperature between 15 and 95° and a pH between 4 and 10.

In any configuration of a process of the invention, the electrolyte solution may comprise the halide SRC and one or more additive.

In any configuration of a process of the invention, the solution may comprise KOH or NaOH.

In any configuration of a process of the invention, the electrolyte solution may comprise a chromium salt.

In any configuration of a process of the invention, the chromium salt may be sodium dichromate.

In any configuration of a process of the invention, the chromium salt may be present at a concentration in the range of 0.1 and 3 g/L.

A process for simultaneously generating hydrogen and oxygen gases, the process comprising
oxidizing a reduced form of a halide SRC being a bromide SRC or a chloride SRC in an electrolytic cell, under conditions complementing hydrogen evolution, without generating oxygen gas,
separating the hydrogen gas,
reducing the oxidized form of the halide SRC to spontaneously generate oxygen gas,
separating the oxygen gas;
   wherein the halide SRC is provided in an electrolyte solution maintained at a pH between 4 and 10 and at a temperature between 15 and 95°.

Each and every embodiment stated herein with regard to a system of the invention may be independently applicable and used to define or state an embodiment of the aforementioned process of the invention.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1: Schematic illustration of a system and process according to some embodiments of the invention, demonstrating a continuous generation of H₂ and O₂ in separate electrolytic and catalytic cells using Br⁻/BrO₃⁻ as a soluble redox couple.

FIGS. 2A-E: Bromide electrolysis tests. Photographs of the electrolytic cells used to examine the bromide electrolysis process with stirred (A-B) and still (C-E) electrolytes. (A) and (C) before electrolysis; (B) and (D) during electrolysis; (E1-E5) sequential snapshots during subsequent steering after electrolysis. The electrolyte composition and other experimental conditions are specified in the Methods section and are summarized in Table 1.

FIGS. 3A-C: Electrolytic efficiency of bromide electrolysis. (A) Steady state current density vs. voltage (IR-corrected) results obtained by galvanostatic measurements at different current densities (FIG. 1) during bromide electrolysis with (blue curve) and without (black curve) borate buffer (0.7M). For comparison, results from previous DWE reports are marked by red symbols (⋄ for SRC, ♦ for SRE, and * for E-TAC) and labeled by the respective references. The electrolyte composition at the beginning of the electrolysis measurements was 1.5M NaBr plus 3.8 mM Na₂Cr₂O₇, with and without borate buffer (0.7M). The electrolyte was heated to 60° C. and stirred at 400 RPM. (B) and (C) Current density vs. potential (IR-corrected) curves of the Pt foil cathode and RuO₂—TiO₂/Ti DSA anode, respectively, obtained by linear sweep voltammetry (LSV) measurements with a potential scan rate of 1 mV/s. The experimental conditions are specified in the Methods section and are summarized in Table 2.

FIG. 4: Stability of bromide electrolysis. The voltage (IR corrected) as a function of time during extended galvanostatic measurements at a current of 600 mA in 1.5M NaBr electrolyte with (red curve) or without 3.8 mM Na₂Cr₂O₇ (all other curves) measured at 60° C. (blue, red and orange curves) or at room temperature (purple and green curves) with (all curves expect for the purple curve) or without stirring (purple curve). Pristine Pt foil/coil (at 60° C./RT respectively) cathode and RuO₂/TiO₂ DSA anode were used in the measurements, except for the one presented by the orange curve where a pre-coated Pt foil cathode from previous electrolysis tests was used. The voltage drift in the red curve results from changes in the electrolyte composition due to conversion of bromide to bromate during the measurement.

FIG. 5: Catalytic decomposition of bromate to bromide and oxygen: Water displacement experimental setup.

FIGS. 6A-C: Catalytic decomposition of bromate to bromide and oxygen: Buffer effect (A) and Na₂Cr₂O₇ effect (B) on the catalytic conversion of BrO₃⁻ to Br and O₂ (Rxn 12). The electrolyte was 1.5M NaBrO₃ (7 mL) and the catalyst mass was ~50 mg in (A) and ~25 mg in (B); (C) Catalytic conversion of 1M bromate solution obtained by bromide electrolysis (FIG. 2B). The solid black curve presents the degree of conversion of bromate to bromide, and the dashed blue curve presents the equivalent electric current.

FIG. 7: Iodometric titration progress from left to right. The color is attributed to I₂ that was initially high in concentration (dark red, left photograph) and upon titration it was reduced until no I₂ was left, and the solution turned colorless (right photograph).

FIGS. 8A-C: Ru Adams catalyst characterization. (A) XRD pattern compared to the JCPDS data of tetragonal RuO₂; (B) SEM micrograph; (C) TEM micrograph.

FIG. 9: Catalytic conversion of 1M bromate solution obtained by bromide electrolysis (FIG. 2B). The solid black curve presents the evolved volume of oxygen due to bromate decomposition, and the dashed blue curve presents the oxygen evolution rate.

FIG. 10: Long term electrolysis stability. A photograph of the measurement setup.

FIG. 11: Long term electrolysis stability. Results showing the bromide (Br) concentration during five days of continuous electrolysis of 300 ml aqueous solution of 1.5 M NaBr (initial composition) with 0.3 M borate buffer and 3.8 mM Na₂Cr₂O₇, at a current of 300 mA, temperature of 60° C., and stirring rate of 400 rpm. The data points present ion chromatography measurements of two duplicate samples.

FIG. 12: Long term electrolysis stability. Results showing the bromate (BrO₃⁻) concentration during five days of continuous electrolysis of 300 ml aqueous solution of 1.5 M NaBr (initial composition) with 0.3 M borate buffer and 3.8 mM Na₂Cr₂O₇, at a current of 300 mA, temperature of 60° C., and stirring rate of 400 rpm. The data points present ion chromatography and iodometric titration of two duplicate samples.

### DETAILED DESCRIPTION OF EMBODIMENTS

The invention disclosed herein presents a new decoupled water splitting process that produces hydrogen and oxygen in separate electrolytic and catalytic cells, respectively, and supports continuous operation in a membrane-less system. The system of the invention demonstrates high efficiency and high rate in a near-neutral electrolyte of NaBr in water, whereby bromide is oxidized to bromate concurrent with hydrogen evolution in the electrolytic cell and bromate is reduced to bromide in a catalytic reaction that evolve oxygen in the catalytic cell. A Faradaic efficiency of 98±2% was achieved in a 1.5M NaBr electrolyte with 3.8 mM Na₂Cr₂O₇ that prevents cathodic loss reactions by coating the cathode, in-situ during operation, with a barrier layer that hinders the electroreduction of oxidized brome species. Under these conditions, no oxygen evolves in the electrolytic cell, enabling safe operation without dividing the cell into cathodic and anodic compartments using expensive membrane and sealing components as in conventional water electrolysis. Adding a borate buffer enhances the hydrogen evolution reaction and reduced the electrolytic cell voltage (IR-corrected) to 1.5 V at a current density of 5 mA/cm², or 2.4 V at 1 A/cm², or 3A/cm² at a voltage of 2.8V. These values correspond to electrolytic efficiency of 98.7% HHV and 61.7% HHV at low and high current densities, respectively, outperforming previous reports on decoupled water splitting using electron-coupled-proton buffers. Another advantage of the process is operation in a near-neutral electrolyte, unlike previous reports on decoupled water splitting in acid or alkaline electrolytes.

Also demonstrated is a fast reduction of the oxidized electrolyte taken from the electrolytic cell by a RuO₂ Adams catalyst in a simple catalytic cell, which is the key to integration of the electrolytic and catalytic sub-processes into a seamless process that splits water and produces hydrogen and oxygen continuously under constant electrolyte flow from one cell to another. Further efforts to develop this breakthrough process into a competitive technology for green hydrogen production should aim at the following goals: (1) Replacing the Pt cathode and RuO₂ anode (DSA) and catalyst (RuO₂ Adams) we used in our proof-of-concept experiments by Earth-abundant alternatives; (2) Replacing the Na₂Cr₂O₇ additive by non-toxic alternatives; (3) Integrating the electrolytic and catalytic sub-processes into a seamless process and validating its long-term performance.

### Methods

Chemicals. Double distilled water (DDW, Direct-Q3 UV, Merck) was used to prepare the aqueous solutions. Piranha solution, comprising a 2:5 mixture of concentrated hydrogen peroxide H₂O₂ (30%, for analysis, Merck) and sulfuric acid H₂SO₄ (95-98%, AR, Bio-Lab, Israel), was used for cleaning the electrolytic cells, glassware, and Pt electrodes before use. Acetone (AR, Bio-Lab, Israel) and ethanol (absolute, AR, Gadot-Group, Israel) were used for cleaning the anode before use. The electrolytes were prepared using sodium bromide NaBr (99+%, Alfa Aesar). The pH values were adjusted with the use of sodium hydroxide NaOH (pearls, AR, Bio-Lab, Israel) solutions. The buffer solutions were prepared with the use of boric acid H₃BO₃ (99.6%, ACS grade, Acros), and phosphate dipotassium phosphate K₂HPO₄ (ACS grade, Spectrum chemical) and monopotassium phosphate KH₂PO₄ (ISO for analysis, Merck). Sodium dichromate dihydrate Na₂Cr₂O₇×2H₂O (ACS grade, Merck) was used as an additive in the electrolyte. Ar gas (Maxima, Israel, 99.999%) was used for purging the electrolyte in the polarization measurements. Ruthenium trichloride hydrate RuCl₃×H₂O (35-40% Ru, Acros Organics) and sodium nitrate NaNO₃ (99+%, ACS grade, Acros) were used for the synthesis of ruthenium dioxide powder (RuO₂ Adams catalyst). Potassium iodide KI (ACS reagent, Spectrum Chemical) and standardized 0.1N solution of sodium thiosulfate (Alfa Aesar) were used for iodometric titration of bromate solutions. Sodium bromate NaBrO₃ (99.5% metal basis, Alfa Aesar) was used to prepare the solutions for the water displacement measurements.

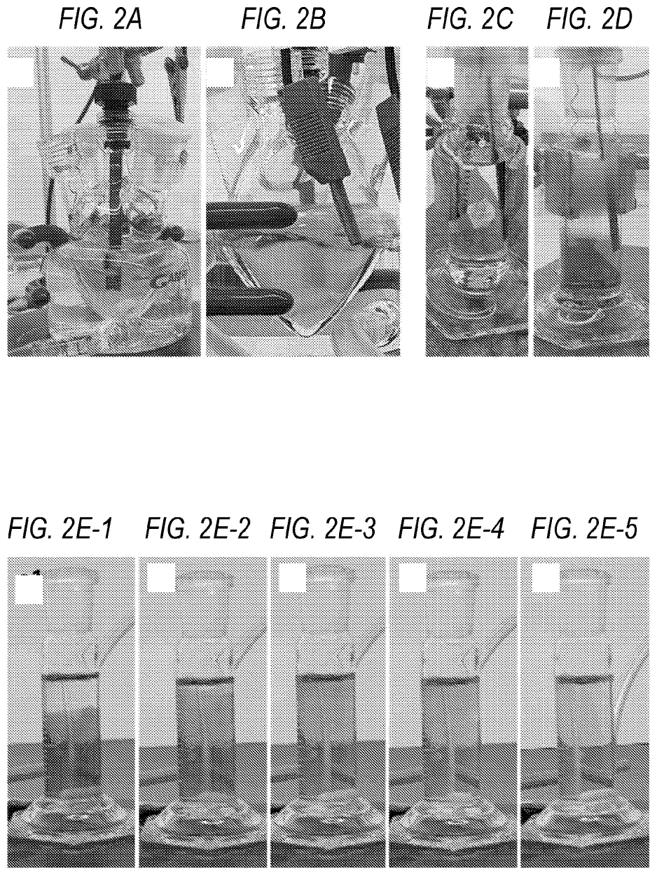

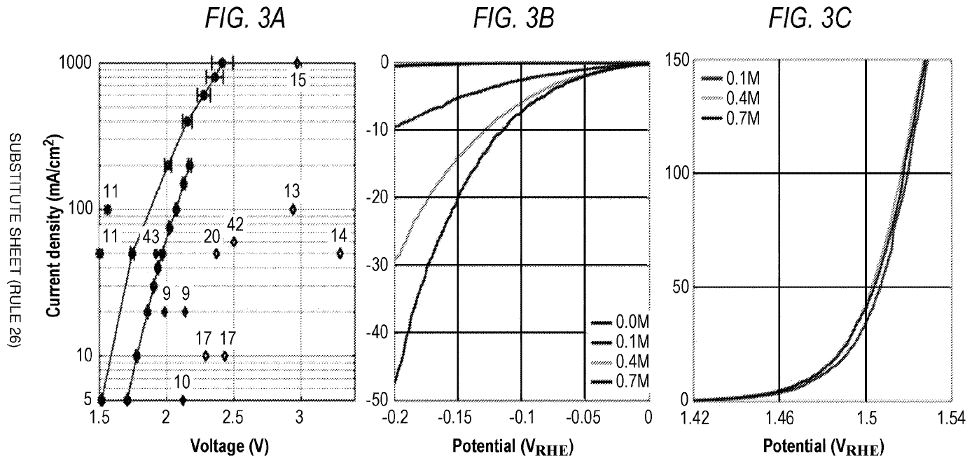

Electrodes. Pt foil (geometric area 2 cm², surface roughness factor ca. 3-4, 99.95%, 0.05 mm thick, Holland Moran) and Pt coil (wire diameter 5 mm, coil diameter and length are 4 and 15 mm, respectively, ALS Co., Japan) electrodes were used as cathodes in the bromide electrolysis measurements presented in FIGS. 2B and 2C, respectively. The same Pt foil (2 cm²) was used as the working electrode (WE) in the cathodic polarization HER measurements presented in FIG. 3B. A smaller piece (0.45 cm²) of the same Pt foil (99.95%, 0.05 mm thick, Holland Moran) was used for the high current density measurements presented in FIG. 3A, to comply with the maximum current limitation (800 mA) of the potentiostat (BioLogic SP-150). The Pt electrodes were cleaned by dipping into piranha solution and then thorough rinsing in DDW before measurements. Commercial RuO₂—TiO₂/Ti dimensionally stable anodes (DSA) (Ti substrate thickness 1 mm, thickness of mixed oxide layer ~20-30 μm, DSA10k, De Nora, Italy) were used as anodes, keeping the geometric area close to that of the corresponding cathode. The DSA anodes were pre-cleaned in the mixture of DDW/ethanol/acetone for 10 min in an ultrasound bath (MRC ultrasonic cleaner, 3L, 120W) and then thoroughly rinsed in DDW. A reversible hydrogen electrode (RHE) (HydroFlex, Gaskatel) was used as the reference electrode (RE) in the three-electrode measurements. It was immersed into the respective electrolyte 1 h before starting the measurements.

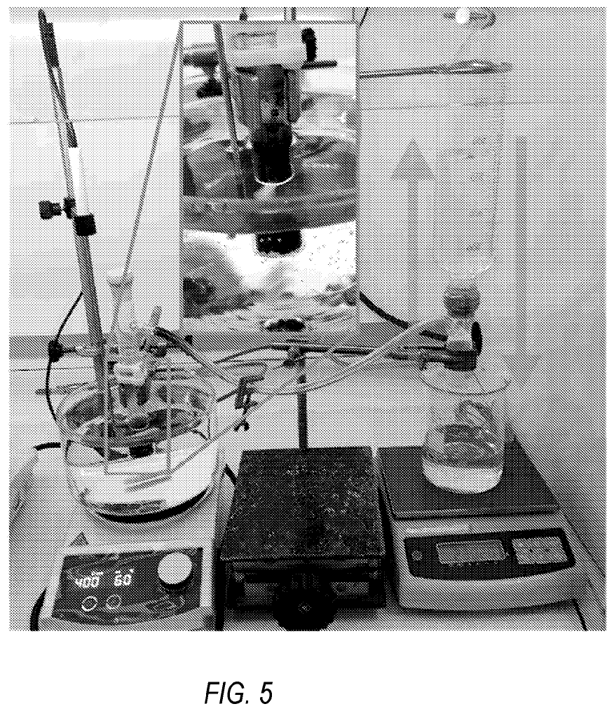

RuO₂ Adams catalyst synthesis. The RuO₂ Adams catalyst used in the bromate reduction process (FIG. 5) was prepared, following a modified Adams process, by grinding together 2 g of RuCl₃×xH₂O and 10 g of NaNO₃ powders with mortar and pestle. The resulting mixture was heated for 5 min in an oven (ELF Laboratory Chamber Furnace, max 1100° C., Carbolite) at 500° C. The oven was placed in a fume hood to safely remove toxic by-products of the reaction such as nitrogen oxide (NO/NO₂) gases. The resulting RuO₂ Adams catalyst was then cooled to ambient temperature and washed with DDW. The washing was repeated 3 times by means of centrifugation (MRC, SCEN-206 centrifuge) and decantation of the unreacted reagents in DDW. The recovered catalyst powder was then dried in air for several days.

Faradaic efficiency measurements. The Faradaic efficiency of bromide electro-oxidation to bromate (Rxn 6) was evaluated for two operational modes under the experimental conditions described in Table 1, using a RuO₂—TiO₂/Ti DSA anode and Pt foil/coil cathode in the same compartment (FIG. 2B and FIG. 2D, respectively). The amount of generated bromate anions was determined at the end of each of the electrolysis tests by iodometric titration and compared with the electric charge, I×t (I—current, t—electrolysis time), that passed between the electrodes during each test. In the first operational mode (FIG. 2A), a double-jacketed electrolytic cell (Dr. Bob, Gamry, FIG. 2A) was used, and the electrolyte, 1.5M NaBr without additives (experiments #1 and #3 in Table 1) or with 3.8 mM Na₂Cr₂O₇ (experiment #2 in Table 1), was heated to 60° C. and stirred at 400 rpm using a Teflon coated magnetic stirrer. In the second operational mode (FIG. 2D, experiments #4 and #5 in Table 1), a cylindrical cell (graduated Pyrex cylinder, 20 ml, Duran) was used, and the electrolyte (1.5M NaBr, without additives) was kept at room temperature (RT). The initial pH of the 1.5M NaBr electrolyte without additives was 5.8, whereas with the Na₂Cr₂O₇ additive it was 7.5.

TABLE 1
Experimental conditions for Faradaic efficiency (FE) measurements.

| | | FE | | | | Cathode | Temp. | Stirring | pH | pH |
|---|---|---|---|---|---|---|---|---|---|---|
| Exp. | FIG. | (%) | Na₂Cr₂O₇ | Cell type | Cathode | coating | (° C.) | (rpm) | initial | final |
| 1 | | 10 ± 1 | — | Double | Pt foil | — | 60 | 400 | 5.8 | 9.2 |
| 2 | 2A-B | 98 ± 2 | 3.8 mM | jacketed | | In-situ* | | | 7.5 | 7.9 |
| 3 | | 80 ± 2 | — | cell | | Ex-situ# | | | 5.8 | 9.5 |
| 4 | 2C-E | 72 ± 2 | — | Cylindrical | Pt coil | — | RT | — | 5.8 | 8.3 |
| 5 | | 13 ± 1 | — | cell | | | | 400 | 5.8 | 10.5 |

Electrolysis current 600 mA, electrolysis duration 5.36 h, 20 ml of 1.5M NaBr electrolyte (without buffer).
*In-situ coating by electrochemical reduction of Cr₂O₇²⁻ anions during electrolysis.
#Using precoated electrodes from prior electrolysis tests.

Iodometric titration. Iodometric titration was used to determine the concentration of bromate anions (BrO₃⁻) in the electrolyte after bromide electrolysis tests. The bromate anions were reduced to bromide anions (Br⁻) in the presence of excessive amount of iodide anions in acidic medium,

$${BrO}_{3}^{-} + 6 {I}^{-} + 3 {H}_{2} {S O}_{4} \to 3 {I}_{2} + {Br}^{-} + 3 {SO}_{4}^{2 -} + 3 {H}_{2} O ,$$

and the liberated iodine (I₂) molecules were titrated by standardized thiosulfate solution, 2Na₂S₂O₃+I₂→2NaI+Na₂S₄O₆. To this end, a solution of 3.8 g of KI in 40 ml DDW was added to an aliquot of 400 μl (V_{aliquot}) that was collected from the electrolytic cell (V_{electrolyte}=20 ml) at the end of the electrolysis experiment, followed by addition 0.6 ml of concentrated sulfuric acid H₂SO₄. After dilution by DDW to a volume of 50 ml the resultant dark-violet solution (FIG. 7, left) was gradually titrated by adding a standardized 0.1N solution of sodium thiosulfate Na₂S₂O₃

$$( {C}_{{S}_{2} {O}_{3}^{2 -}} = 0.1 M )$$

until reaching a transparent solution (FIG. 7, right). The volume of the thiosulfate solution that was added to this point,

$${V}_{{S}_{2} {O}_{3}^{2 -}} ,$$

was used to calculate the amount of bromate ions that was generated by the electrolysis:

$${n}_{{BrO}_{3}^{-}} = \frac{{V}_{{S}_{2} {O}_{3}^{2 -}} {C}_{{S}_{2} {O}_{3}^{2 -}}}{{V}_{aliquot}} {V}_{electrolyte} .$$

Cathodic polarization measurements. The cathodic polarization curves presented in FIG. 3B were measured by linear sweep voltammetry in a three-electrode water-jacketed electrolytic cell (Dr. Bob), using a Pt foil (2 cm²) as working electrode (WE) and a potentiostat (BioLogic SP-150) at a scan rate 1 mV/s. A Pt wire (diameter 5 mm, Gamry) placed in a separate fritted glass compartment was used as a counter electrode (CE), where bromide electro-oxidation took place. A reversible hydrogen electrode (RHE) was used as a reference electrode (RE). The RE and WE were placed in the same compartment. The series resistance R was measured by current interruption method before each measurement. Measurements were carried out in Ar-purged 1.5M NaBr electrolytes containing different additives at 60° C. The basicity of the electrolyte was adjusted to pH 8 using a 5M NaOH solution using an Oakton pH/mV/° C. pH-meter (series 500). In short experiments that correspond to several polarization curves, the addition of sodium dichromate to the electrolyte was found to have a negligible effect on the polarization curves, therefore it was not used in the cathodic polarization measurements. No stirring was applied in these measurements to minimize interference by back reactions of the products of bromide electro-oxidation at the CE.

Anodic polarization measurements. The anodic polarization curves presented in FIG. 3C were measured similarly to the cathodic polarization measurements, with the following exceptions: First, a DSA10K anode (2 cm²) was used as a WE; and second, the WE and CE (Pt coil) were placed in the same compartment, so that the hydroxide anions (OH⁻) formed at the CE (Rxn 1) would not be restricted to react with Br₂ formed at the WE (Rxn 2) in the bulk solution (Rxn 3).

Electrolytic efficiency. The electrolytic efficiency of the hydrogen and bromate evolution reactions (HER and BER, respectively) were evaluated from the steady-state current-voltage curve presented in FIG. 3A. To this end, galvanostatic measurements were carried out at different currents in a two-electrode cell configuration (FIG. 2A) using a BioLogic SP-150 potentiostat with a Pt foil cathode and a DSA10K anode. The electrolyte was 1.5M NaBr with sodium dichromate additive (3.8 mM), without a buffer or with 0.7M borate buffer (black and blue curves in FIG. 3A, respectively). The electrolyte was heated to 60° C. in a double-jacketed electrolytic cell (Dr. Bob) and stirred at 400 rpm. Current density values from 5 to 1000 m/cm² were applied in ascending order, holding for 5 min at a time, while monitoring the applied voltage. The voltage values were averaged to obtain the mean value and standard deviation at each current density and corrected for the Ohmic (IR) drop. The resistance R was measured by electrochemical impedance spectroscopy (EIS) using a BioLogic SP-150 potentiostat and was determined as the high-frequency intercept with the real axis in the Nyquist plot. The EIS measurements were conducted in a galvanostatic mode at the same currents of the current—voltage measurements, with an oscillation amplitude of 5% of the mean current and oscillation frequency from 200 kHz to 100 mHz. The IR-corrected mean voltage values, V_{cell}, were used to calculate the electrolytic efficiency based on the higher heating value (HHV) of hydrogen, η=(1.48/V_{cell})×100% HHV.

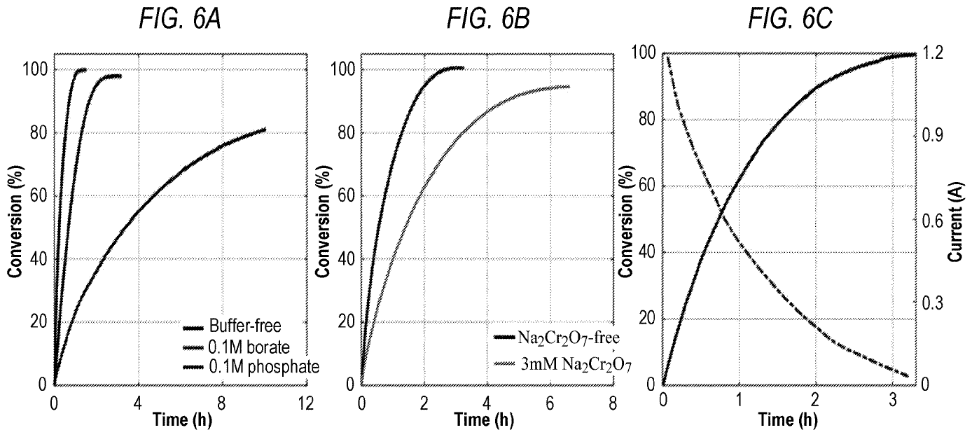

Bromate catalytic decomposition. The water displacement technique was used to monitor the kinetics of the bromate catalytic decomposition (Rxn 12) on the RuO₂ Adams catalyst. The method is based on weighing the amount of water displaced by the oxygen released in the reaction. The experimental setup, presented in FIG. 5, comprises of a gas-tight glass reactor placed in a water bath on top of a heated plate and a water column. The outlet of the reactor is connected to the inlet of a water column, whereas the outlet of the column is directed to a beaker that is placed on a digital balance that monitors the mass change as a function of time during the decomposition reaction. Before the start of the experiment, the tube is closed by a metal pinch clamp. To start the measurement, a known volume (Vₛₒₗ=7 ml) of NaBrO₃ solution with a known concentration of bromate anions (CBrO₃⁻=1.5M) is added to the reactor that contains a known mass of the RuO₂ Adams catalyst (mRuO₂). Then, the reactor is sealed, and the pinch clamp is opened. The oxygen gas that evolves in the reactor flows to the water column through the tube and displaces the water from the column to the beaker, and the mass of the displaced water (m_{water}) is constantly measured. The measured mass (in kg) is nearly equal to oxygen volume (Vo₂, in L) since the density of water is 0.998 kg/L in STP. The oxygen volume, Vo₂, is converted to number of moles of oxygen, no₂, by the ideal gas law (PV=nRT). Taking a ratio of 2:3 between the bromate anions converted to bromide and the generated O₂ molecules (Rxn 12), the degree of conversions is 2 no₂/3 Vₛₒₗ CBrO₃⁻, presented in FIG. 6A,B as a function of the reaction time (t). The slope s=dnO₂/dt yields a reaction rate, which can be converted to an equivalent electric current I=4×F×s (presented in FIG. 6C, blue curve), where F is Faraday's constant and 4 in the number of electrons needed to generate an oxygen molecule by the oxygen evolution reaction. The conversion degree values were verified independently by end-of-experiment iodometric titrations, confirming full decomposition of bromate to bromide with close to 100% oxygen yield at the end of the experiments.

The water displacement technique was applied for a series of experiments with different catalyst to solution volume ratios and with different electrolyte additives including dichromate, phosphate buffer and borate buffer (Table 2).

TABLE 2
Experimental conditions for catalytic decomposition experiments.
All the measurements were carried out in a heated and stirred 1.5M
NaBrO₃ electrolyte (60° C., 400 rpm). The initial pH was 8.

| | | RuO₂ | |
|---|---|---|---|
| | Initial | Adams mass | |
| FIG. | rate (s⁻¹) | (mg) | Additives |
| — | 0.0310 | 102.8 | No |
| 5A | 0.0362 | 51.2 | |
| 5B | 0.0349 | 25.5 | |
| 5A | 0.0041 | 51.6 | 0.1M phosphate buffer |
| 5A | 0.0068 | 55.0 | 0.1M borate buffer |
| 5A | 0.0168 | 25.4 | 3 mM Cr₂O₇²⁻ |

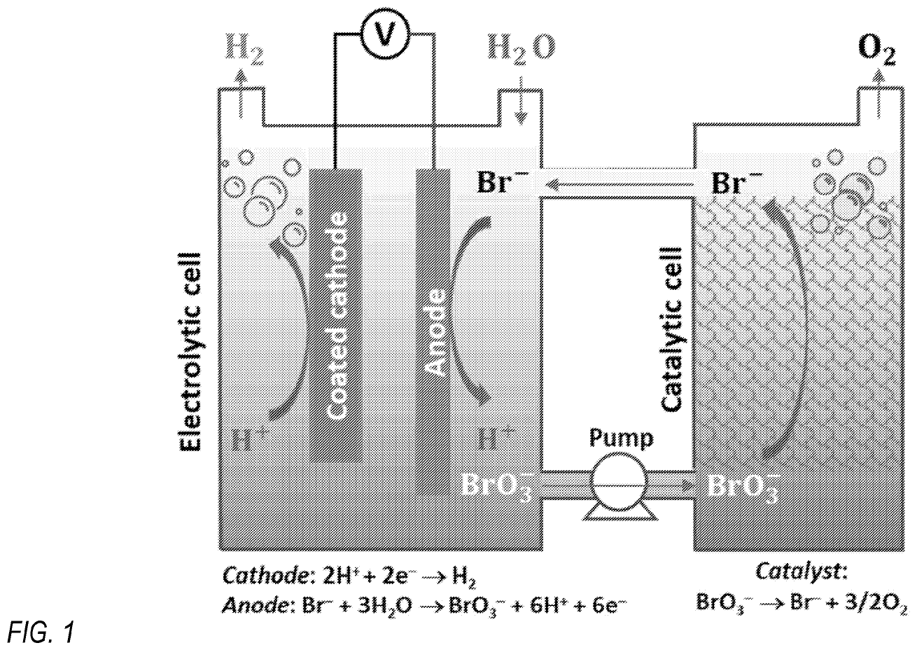

The feasibility of the proposed DWE process (FIG. 1) was validated separately in two sets of experiments that examine the performance of the electrolytic and catalytic sub-processes. Then, complementary measurements were carried out combining the two sub-processes into a unified batch-to-bath process that splits water into hydrogen and oxygen in separate cells.

Electrolytic process: The electrolytic process was examined in two operational modes. The first (main) mode corresponds to bromate electrolysis in 1.5M NaBr electrolyte with the addition of 3.8 mM Na₂Cr₂O₇, where the electrolyte was heated to 60° C. and stirred during the process. In the second mode, we examined the possibility to carry out the process in a pristine 1.5M NaBr electrolyte without the toxic Na₂Cr₂O₇ additive by utilizing the phase separation between the high-density bromine (Br₂) that forms on the anode (Rxn 2) and the rest of the electrolyte (which is lighter) to minimize the diffusion of reaction products to the cathode and suppress cathodic loss reactions (Rxns 8-11). To suppress mixing the heavier and lighter parts of the electrolyte, the electrolysis was carried out in an unheated electrolyte (~20° C.) without stirring. FIG. 2 presents photographs of the electrolysis tests carried out in the first mode (FIGS. 2A-B) and in the second mode (FIGS. 2C-D). In both cases, the anode (RuO₂—TiO₂/Ti DSA) and cathode (Pt foil in the first mode and Pt coil is the second mode) were placed in an electrolytic cell with no membrane or diaphragm division. The addition of Na₂Cr₂O₇ in the first operational mode resulted in a yellowish solution (prior to electrolysis), as shown in FIG. 2A, whereas in its absence in the second mode the electrolyte was colorless (FIG. 2C). During operation in the first mode (FIG. 2B), the whole volume of the electrolyte becomes cloudy due to the evolution of hydrogen bubbles that were stirred throughout the cell. The electrolyte color remained yellowish, comprising contributions from both the Cr₂O₇²⁻ anions and the bromide oxidation intermediates. The operation in the second mode resulted in an intense hydrogen bubbles formation at the top of the cylindrical cell, along with a phase separation between the red Br₂-rich solution that sank down to the bottom of the cell, and the yellowish solution that contained some small amount of oxidized bromine species in the upper part of the cell. We note that in this experiment the Pt-coil cathode was made shorter than the DSA anode (FIG. 2C) to enhance the phase separation in order to examine if it may contribute to membrane-less operation without Na₂Cr₂O₇. Post-electrolysis stirring turned the phase-separated red and yellowish solutions into a homogeneous yellowish solution (FIGS. 2, e1-e5), indicating that the Br₂-rich solution reacted with the rest of the electrolyte according to Rxns 3-5. However, a residual amount of unreacted intermediate products remained, as indicated by the yellow color of the stirred solution.

The Faradaic efficiency of bromide electrooxidation was examined for both operational modes, with and without Na₂Cr₂O₇, by electrolyzing 20 ml of 1.5M NaBr electrolyte (without buffers) for 5.36 hours at a current of 600 mA (total charge 11578 C) and analyzing the resulting bromate content by iodometric titration. Considering that six electrons are needed to oxidize a bromide anion to a bromate anion (Rxn 6), this charge should produce 0.02 moles of bromate anions at 100% Faradaic efficiency and convert 2/3 (1M) of the bromide anions in the initial electrolyte (20 ml of 1.5M NaBr) to bromate anions. In the first operational mode (FIG. 2B), with the Na₂Cr₂O₇ additive and stirring, the Faradaic efficiency was 98±2%. Without the Na₂Cr₂O₇ additive (but otherwise the same conditions), the Faradaic efficiency dropped to 10±1%, indicating the important role of Na₂Cr₂O₇ to prevent Rxns 8-11 by forming a polyoxide cathodic barrier, as reported elsewhere. In the second operational mode (FIG. 2D), without Na₂Cr₂O₇, the Faradaic efficiency was 72±2% without stirring, and it dropped to 13±1% with stirring, demonstrating the effectiveness of the spontaneous phase separation between the oxidized electrolyte and the rest of the electrolyte in suppressing the cathodic loss reactions (Rxns 8-11). Although this encouraging result is not as prominent as that obtained in the presence of Na₂Cr₂O₇ (in the first operational mode), it suggests that the Faradaic efficiency may be further enhanced by removing the oxidized electrolyte from the bottom of the cell in a flow system that connects the electrolytic cell with the catalytic cell, as illustrated in FIG. 1. This would constantly drain the oxidized electrolyte from the electrolytic cell, reducing the cathodic backward reactions further than what has been achieved in this experiment without removing the oxidized electrolyte. This approach may lead the way to high efficiency operation in a benign NaBr electrolyte without Na₂Cr₂O₇. A similar approach has been reported in membrane-less zinc-bromine redox flow batteries, harnessing the phase separation in the electrolyte to suppress backward reactions like those occurring in our system.

An alternative solution to suppress the cathodic loss reactions without using Na₂Cr₂O₇ is precoating the cathode (ex-situ) with chromium polyoxide (or other) layer instead of in-situ deposition of Cr₂O₇²⁻ anions during operation in the presence of Na₂Cr₂O₇. We have achieved partial success pursuing this approach by using a precoated cathode that was taken after going through previous electrolysis tests with Na₂Cr₂O₇ in the solution, reaching a Faradaic efficiency of 80±2% in subsequent tests without Na₂Cr₂O₇. We suspect that the lower Faradaic efficiency of the precoated cathode with respect to in-situ coating during electrolysis in the presence of Na₂Cr₂O₇ in the electrolyte may arise from imperfect coating and/or detachment of small segments of the coating layer during operation. Apparently, in the presence of Cr₂O₇²⁻ anions in the electrolyte the barrier layer is more effective than the ex-situ precoating, probably due to self-healing of the polyoxide layer during operation. The high Faradaic efficiency obtained in the first operational mode with Na₂Cr₂O₇ also serves as an indication that the rate of the OER, an undesired side reaction that may compete with the bromide oxidation reaction (Rxn 2) under non-optimal conditions, is negligible in our case.

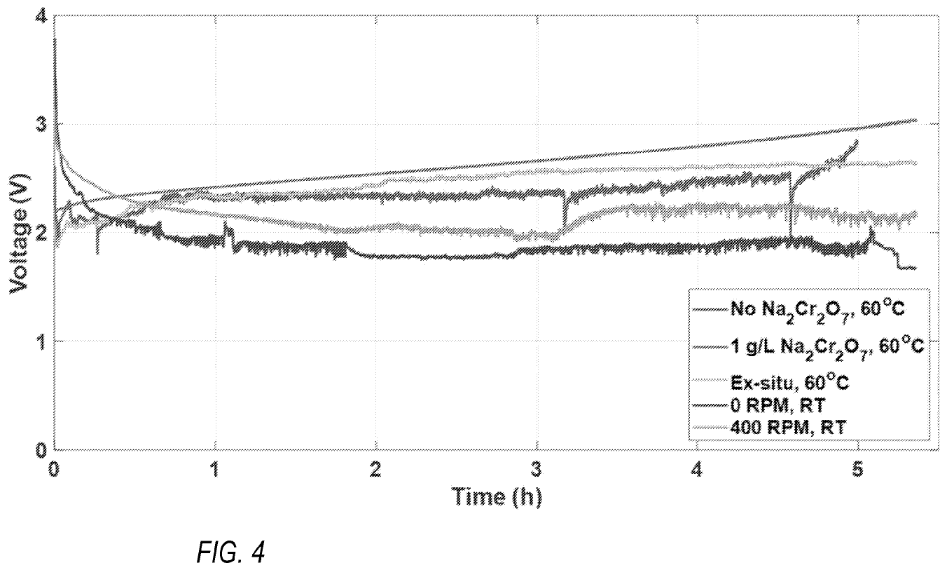

Further to the Faradaic efficiency measurements, the electrolytic (i.e., voltage) efficiency was measured for the first operational mode (FIG. 2B) that demonstrated the highest Faradaic efficiency (98±2%). This was done by two-electrode galvanostatic voltammetry measurements at different current densities ranging from 5 to 1000 mA/cm² (FIG. 1). FIG. 3A presents the steady state current density vs. voltage results obtained for bromide electrolysis in unbuffered (black) and buffered (0.7M borate buffer, blue) 1.5M NaBr electrolytes with 3.8 mM Na₂Cr₂O₇, heated to 60° C. Introducing 0.7M borate buffer decreases the cell voltage by ~0.2 V at current densities up to 50 mA/cm², resulting in a low onset voltage of 1.5 V at a current density of 5 mA/cm². The reduction in cell voltage is slightly lower at higher current densities, but it remains significant even at 200 mA/cm². A cell voltage of 2.4 V was obtained at a high current density of 1 A/cm². As a result of the cell voltage reduction by the borate buffer, the electrolytic cell efficiency increased from 86 to 97% HHV at 5 mA/cm², and from 75 to 85% HHV at 50 mA/cm². Comparing our results (black and blue curves) with previous reports on DWE, marked by red symbols (⋄, ♦ and *), shows that the electrolytic performance of our process surpasses previous DWE reports using SRC and SRE (marked by open and solid squares, ⋄ and ♦, respectively), except for the E-TAC process (marked by stars, *). E-TAC water electrolysis presents the lowest cell voltage, 1.5 V at a current density of 50 mA/cm², but it only goes as high as 100 mA/cm² whereas our process reaches 1 A/cm². It is also noted that, unlike E-TAC which is a batch process with frequent thermal swings that require additional thermal energy to heat the hot electrolyte at the transition from the cold stage to the hot stage, our process is designed to operate under continuous and isothermal electrolyte flow (FIG. 1), avoiding this thermal loss. As a result, the gap between the efficiency at the cell level, which is presented here, and at system level, which can only be examined in a scaled-up system, is expected to be smaller for our process than for the E-TAC process. Therefore, our process may be more efficient, at system level, than any other DWE process reported before, including E-TAC. We also note that stable operation was observed on extended galvanostatic measurements for 5.5 h (FIG. 4).

To assess the individual contributions of the cathodic and anodic reactions to the voltage of our process, we analyzed the cathodic (HER) and anodic (BER) polarization losses by means of LSV measurements in a three-electrode cell. The results are presented in FIGS. 3B and 3C, showing the current density as a function of the IR-corrected potential of the Pt foil cathode and RuO₂—TiO₂/Ti DSA anode, respectively. The LSV measurements were carried out in 1.5M NaBr electrolytes containing different borate buffer concentrations (0, 0.1, 0.4 and 0.7 M, marked by black, red, green, and blue curves, respectively), under the same conditions (60° C., pH 8) as in the first operational mode of the galvanostatic voltammetry measurements except for not adding Na₂Cr₂O₇ (see Methods section and Table 3 for details).

TABLE 3
Experimental conditions for electrolytic efficiency experiments. All the measurements
were carried out in a heated electrolyte (60° C.). The initial pH was 8.

| FIG. | Method | Electrodes | Electrolyte | Buffer | Stirring |
|---|---|---|---|---|---|
| 3A | galvanostatic | DSA anode | 1.5M NaBr | — | 400 RPM |
| | 2-electrode- | Pt foil | 3.8 mM Na₂Cr₂O₇ | 0.7M borate | |
| | cell | cathode | | | |
| 3B | LSV | Pt foil WE | 1.5M NaBr | — | — |
| | 3-electrode- | Pt wire CE | | 0.1M borate | |
| | cell | RHE RE | | 0.4M borate | |
| | | | | 0.7M borate | |
| 3C | LSV | DSA W | 1.5M NaBr | 0.1M borate | |
| | 3-electrode- | Pt coil CE | | 0.4M borate | |
| | cell | RHE RE | | 0.7M borate | |

One can see that the cathodic reaction (FIG. 3B) requires a much higher overpotential than the anodic counterpart (FIG. 3C), e.g., above 0.2 V at a cathodic current density of 50 mA/cm² as compared to less than 0.1 V at the same anodic current density. Thus, the HER presents the main polarization loss in our electrolytic process. The addition of borate buffer enhances the HER kinetics and reduces the cathodic overpotential loss (at a given current density) substantially (FIG. 3B), with negligible effect on the anodic loss (FIG. 3C). The beneficial effect of the borate buffer in reducing the cathodic overpotential loss is attributed to serving as a proton source in our near neutral NaBr electrolyte and suppressing local pH gradient at the cathode.

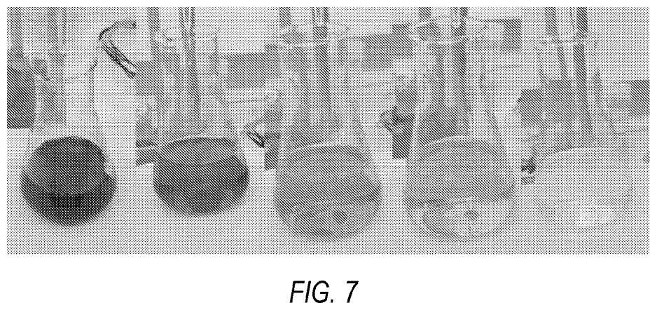

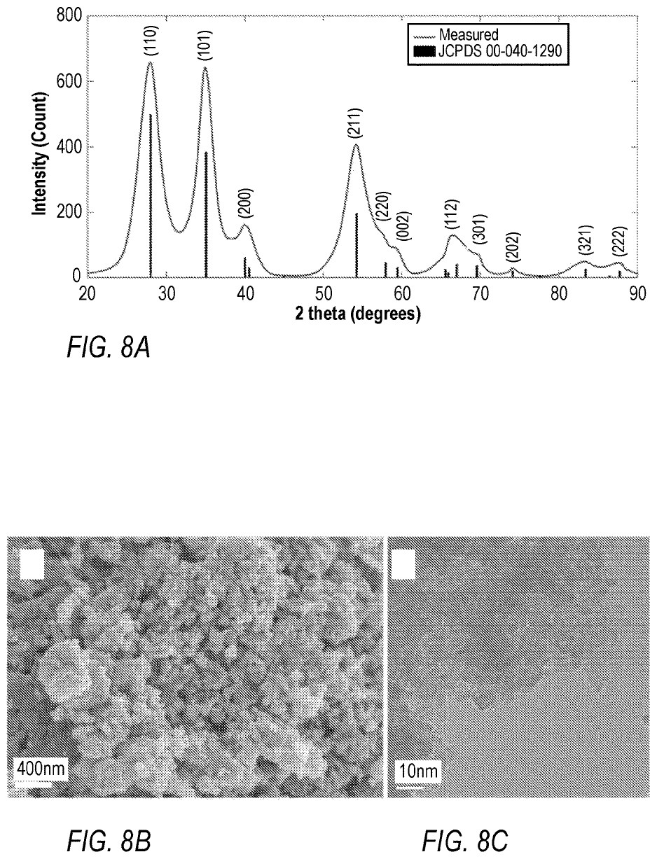

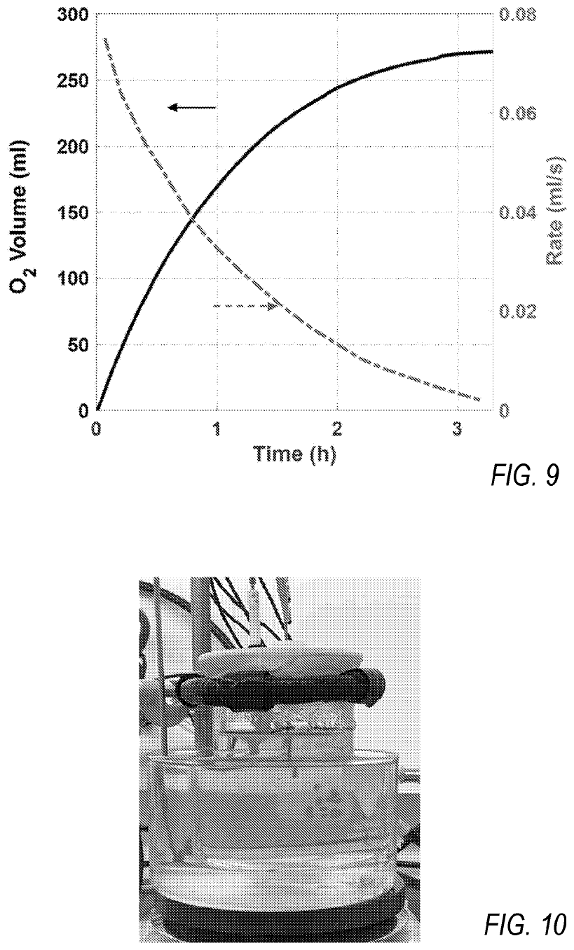

Catalytic process: The kinetics of bromate decomposition to bromide and oxygen (Rxn 12) was studied using a RuO₂ catalyst which was chosen based on previous reports. The catalyst was synthesized using the Adams method as described in the Methods section. The RuO₂ Adams catalyst was composed of the rutile phase as evidenced from the XRD diffractogram presented in FIG. 8A. It had a granular structure comprising sub-micron aggregates, as shown in SEM and TEM micrographs presented in FIGS. 8B-C, with a BET surface area of 170±5 m²/g (FIG. 8B) and pore sizes in the range of 50-58 Å (FIG. 8C). The conversion of bromate to bromide was measured by monitoring the volume of the effluent oxygen gas as a function of time during the catalytic decomposition of 1.5M NaBrO₃ aqueous solution (pre-heated to 60° C.) in the presence of the catalyst, using the water displacement method (see Methods section for details, a picture of the system in FIG. 5). We note that some of the catalyst was washed away by the effluent oxygen gas out of the catalytic cell, as shown by the dark color of the tube connecting the cell to the water column (see FIG. 5). This artefact disables precise quantitative assessment of the specific activity of the catalyst. Nevertheless, the experiments presented herein suffice as a proof-of-concept to demonstrate the process functionality and performance. Future development of this process should immobilize the catalyst by embedding it in a porous support.

First, we examined the effect of borate and phosphate buffers (0.1M) on the reaction kinetics, using ~50 mg of the RuO₂ Adams catalyst. FIG. 6A presents the degree of conversion of bromate to bromide as a function of time for the baseline solution (1.5M NaBrO₃) without (black curve) and with borate and phosphate buffers (blue and red curves, respectively). Without a buffer, full conversion is achieved in ~1.2 h, and the initial reaction rate is 0.0362 s⁻¹. Buffer addition (0.1M) to the baseline electrolyte has an adverse effect on the bromate decomposition kinetics (FIG. 6A), which is worse for phosphate buffer than for borate buffer. For the borate buffer, the initial reaction rate is 0.0068 s⁻¹ and full conversion is achieved in ~2.5 h, whereas for the phosphate buffer the initial reaction rate drops to 0.0041 s⁻¹ and full conversion is not achieved in the timeframe of this measurement (10 h). Next, the effect of Cr₂O₇²⁻ (3 mM) on the reaction kinetics was examined, using 25 mg of the RuO₂ Adams catalyst. The results are presented in FIG. 6B. In the NaBrO₃ electrolyte without Cr₂O₇²⁻ (black curve) full conversion is achieved in ~2.8 h and the initial reaction rate is 0.0349 s⁻¹. The addition of Na₂Cr₂O₇ reduces the initial reaction rate to 0.0168 s⁻¹, and delays the achievement of full conversion to ~6.4 h. The catalytic deactivation in the presence of phosphate and borate buffers and Cr₂O₇²⁻ additive could possibly be attributed to the competitive adsorption of their ions on the surface of the catalyst which interferes with the bromate adsorption on the active centers. The level of deactivation depends on the type and concentration of the interfering species, therefore tuning these parameters is important for the seamless integration of the electrolytic and catalytic sub-process where the electrolyte flows from one cell to another, as illustrated in FIG. 1.

Batch-to-batch process: To demonstrate the feasibility of our proposed DWE process (FIG. 1) we combined the electrolytic and catalytic sub-processes into a batch-to-batch process. An aliquot of 7 ml out of 20 ml of the oxidized electrolyte was taken from the best performance electrolytic test (FIG. 2B) after converting 1M of bromide to bromate and was transferred to the catalytic cell with 50 mg of the RuO₂ Adams catalyst that decomposed the bromate anions to bromide anions and oxygen. The volume of the effluent oxygen gas was measured (FIG. 5) and converted to degree of conversion, presented as a function of the reaction time in FIG. 6C (black solid curve). The results show complete conversion (100%) of electrolytically obtained bromate to bromide and oxygen after ~3 h. This demonstrates a full cycle of hydrogen evolution and bromide electrooxidation to bromate with ~100% Faradaic efficiency in the electrolytic cell, coupled with complete conversion of the bromate formed in the electrolytic cell back to bromide with stoichiometric oxygen evolution in the catalytic cell.

Coupling the electrolytic and catalytic cells in a joint flow system is beyond the scope of this study, which presents a proof-of-principle of a new DWE process and demonstrates it basic functionality and performance. In a complete system with continuous electrolyte flow between the two cells it is important to match the rate of bromate formation in the electrolytic cell with the rate of its conversion back to bromide in the catalytic cell. To compare these rates in our system, the rate of oxygen evolution that was measured in the catalytic cell (FIG. 5) was converted to an equivalent electric current, I_{eq}, by assigning four electrons per O₂ molecule, shown by the dashed blue curve in FIG. 6C. At the beginning of the reaction, the conversion rate corresponds to a high current of over 1 A. This indicates a fast catalytic reaction that would not limit the electrolytic reaction. In future development of the continuous process several parameters should be tuned to match the rates of the bromate formation and decomposition in the electrolytic and catalytic cells, respectively. In the electrolytic cell, the applied current density, electrode size, and the electrolyte composition and volume should be adjusted. In the catalytic cell, the length and diameter of the catalytic column, the amount of catalyst and the porous support in which it is embedded should be properly matched with the electrolytic current and electrolyte flow rate to support a seamless continuous operation.

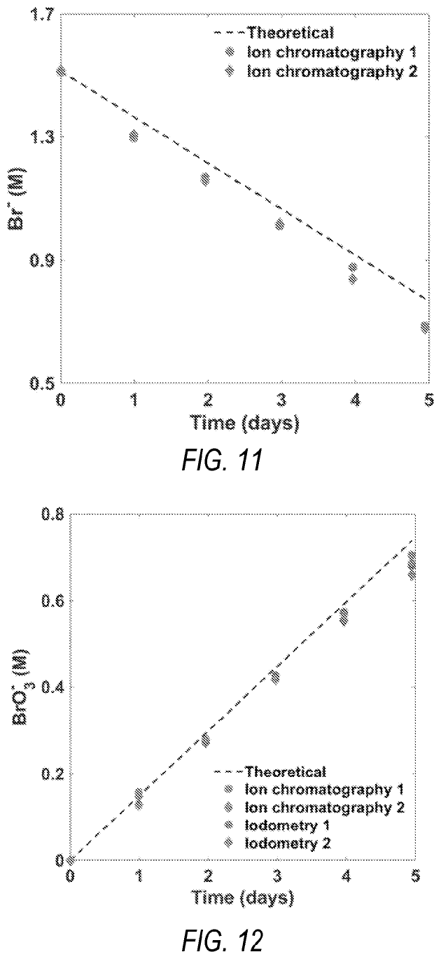

Long-term stability: Faradaic efficiency measurements were carried out during five consecutive days with 119 h of continuous electrolysis at a current of 300 mA (current density of 150 mA cm⁻²). A large (500 ml) cylindrical cell with a Pt foil cathode and DSA (anode) was filled with 300 ml of the electrolyte (initial concentration, 1.5 M NaBr, 0.3 M borate buffer and 3.8 mM Na₂Cr₂O₇ (FIG. 10). The cell was heated to 60° C. and stirred at 400 r.p.m. To reduce evaporation, the cap was sealed to the cell with a Parafilm laboratory film. The bromide and bromate concentrations were measured by sampling the electrolyte approximately every 24 h during the test and analysing the sample composition by iodometric titration and ion chromatography. The results are presented in FIGS. 11 and 12, respectively. The pH was measured each day, and the results were in the range of 8.0 to 8.6.

1-58. (canceled)

59. A redox system for continuous generation of hydrogen gas and oxygen gases, the system comprising a plurality of reactors for cycling a halide-based electrolyte solution comprising a soluble halide redox couple (halide SRC), such that the halide SRC in a reduced state is oxidized in an electrochemical reaction complementing hydrogen gas evolution, without evolution of oxygen gas, and the oxidized halide SRC, in presence of a catalyst, spontaneously evolves oxygen.

60. The system according to claim 59, the system comprising a hydrogen gas separator for removing the hydrogen gas and an oxygen gas separator for removing the oxygen gas.

61. The system according to claim 59, wherein the plurality of reactors being connected through an electrolyte flow of said halide-based electrolyte solution.

62. The system according to claim 59, wherein at least one reactor is an electrolytic cell (or reactor) and another of said plurality of reactors is a catalytic cell (or reactor).

63. The system according to claim 59, the system comprising the plurality of reactors and means to directionally cycle the redox active halide-based electrolyte solution between said reactors, wherein the electrolyte solution comprises a halide mixture of oxidized and reduced forms of the halide SRC.

64. The system according to claim 59, wherein the electrolyte solution comprises a mixture of oxidized and reduced forms of the halide SRC, wherein an enriched concentration of the oxidized form is present at an exit of the electrolytic cell, and more of the reduced form is present at an exit of the catalytic cell.

65. A system for continuous generation of oxygen and hydrogen gases, the system comprising an electrode assembly and two or more reactors, wherein
at least one of said reactors being an electrolytic cell comprising an electrode assembly and configured to oxidize halide electrolyte ions into a corresponding oxidized halide form and to evolve hydrogen gas; and
at least one another of said reactors being a catalytic cell comprising at least one catalyst capable of reverting the oxidized halide form of the electrolytic cell to a reduced form;
wherein the oxidized halide electrolyte is flown from the electrolytic cell to the catalytic cell and the reduced halide electrolyte is flown from the catalytic cell to the electrolytic cell.

66. The system according to claim 65, the system comprising a hydrogen gas separator and an oxygen gas separator.

67. The system according to claim 65, the system comprising an electrode assembly in the electrolytic cell, wherein said assembly comprises an anode formed from RuO₂ or comprising RuO₂.

68. The system according to claim 67, wherein the anode is a TiO₂/Ti supported RuO₂ dimensionally stable anode (RuO₂—TiO₂/Ti DSA), and wherein the cathode is a Pt electrode coated with a semipermeable film of chromium hydroxide.

69. The system according to claim 70, wherein cathode being provided with a semipermeable chromium hydroxide film.

70. The system according to claim 59 being membrane-less.

71. The system according to claim 59, wherein the halide-based electrolyte solution comprises a halide SRC selected to have a reversible redox potential (E0) greater than a thermodynamic oxygen evolution reaction (OER) potential.

72. The system according to claim 59, wherein the catalytic cell comprises a catalyst material immobilized within the boundaries of the catalytic cell.

73. The system according to claim 59, comprising a catalyst for causing reduction of the oxidized form of the halide SRC.

74. The system according to claim 73, wherein catalyst is or comprises RuO₂ or is or comprises Ru₁₋ₓMₓO₂, wherein M is a metal selected from Ni, Mo, Co, Mn, Fe, V, and Cr, and wherein 0.5<x<1.

75. A process for simultaneously generating hydrogen and oxygen gases, the process comprising oxidizing a reduced form of a halide SRC in an electrochemical reaction under conditions complementing a hydrogen evolution reaction (HER), without evolving oxygen gas, and reducing the oxidized form of the halide SRC to spontaneously generate oxygen gas.

76. The process according to claim 75, comprising separating the hydrogen gas following the HER reaction and separating the oxygen gas spontaneously generated following reduction of the oxidized form of the SRC.

77. A process for simultaneously generating hydrogen and oxygen gases, the process comprising:
oxidizing a reduced form of a halide SRC being a bromide SRC or a chloride SRC in an electrolytic cell, under conditions complementing hydrogen evolution, without generating oxygen gas,
separating the hydrogen gas,
reducing the oxidized form of the halide SRC to spontaneously generate oxygen gas, and
separating the oxygen gas,
wherein the halide SRC is provided in an electrolyte solution maintained at a pH between 4 and 10 and at a temperature between 15 and 95°.
